(19) United States
(12) Patent Application Publication
(10) Pub. No.: US 2014/0105727 A1
(43) Pub. Date: Apr. 17, 2014

(54) MEASUREMENT INSTALLATION FOR BLADE FAILURE TESTING IN A TURBOMACHINE

(71) Applicant: SNECMA, Paris (FR)

(72) Inventors: Stephane ROUSSELIN, Hericy (FR); Jean-Francois ADNOT, Viry Chatillon (FR); Patrick MARCELLIN, Savigny Le Temple (FR)

(73) Assignee: SNECMA, Paris (FR)

(21) Appl. No.: 14/051,749

(22) Filed: Oct. 11, 2013

(30) Foreign Application Priority Data
Oct. 12, 2012 (FR) 12 59738

(51) Int. Cl. F01D 21/00

(52) U.S. Cl. CPC F01D 21/003
USPC 415/118

(57) ABSTRACT

Turbomachine fitted with a device for gathering the information recorded during operation of the former by a strain gauge positioned on a fan blade borne by a fan disc of said turbomachine, said device comprising a hollow cylindrical pipe positioned inside one of the rotating shafts of said turbomachine in order to guide at least one wire for transmitting this information, characterized in that said device further comprises a part for attaching said pipe to said rotating shaft.

The field of the present invention is that of turbomachines and, in particular, that of instrumentation for testing these turbomachines.

Before entering service, turbomachines must undergo numerous tests intended to ensure both that they function correctly when in use and that they are able to withstand possible mechanical failures of one of their components. It is particularly expedient to show a turbomachine's capacity to maintain its physical integrity, and to contain fragments which may become detached from the machine, in the event of a fan blade failure. To that end, retention tests are organized, before the turbomachine is certified, in which one of the fan blades is made to fail. It is essential during these tests to measure the stresses to which the various components are subjected and instrumentation is installed specifically on these, and in particular on the fan blades, during the tests.

Strain gauges, fitted with a wire, are thus placed on the fan blades in order to measure, at several locations, the stresses to which the blades are subjected during the test. The instrumentation installed is rotating instrumentation, wherein all the elements are driven in rotation together with the fan blades. The measured values must be conveyed out of the turbomachine and, to that end, the wires of the gauges are connected, via a connector, to measurement-transmitting wires which are located close to the axis of the engine and which run inside the low-pressure shaft thereof. For the testing, a pipe is therefore put in place inside the LP shaft in order to contain this wire and guide it out of the engine.

The instrumentation is generally installed as follows:

The fan blades are first of all pre-fitted with strain gauges, with their gauge wires left loose, and measurement-transmitting wires are placed in a pipe inside the LP shaft. The fan blades are mounted on the disc and the wires from the gauges are connected, using suitable connectors, to the measurement-transmitting wires. Moreover, the various wires are clipped onto the parts in order to avoid them moving under the effect of the forces which act when the engine being tested is in rotation.

In order to make this installation possible, the various wires are produced with excess lengths of wire which must be positioned, after installation, in a particular location where they are not at risk of becoming tangled, which could cause them to break during use. In the prior art, the excess length of these wires was located below the fan, between the bulb-shaped parts of the fan discs, there being generally two of these. The first drawback of this configuration is that it is almost impossible to attach the wires, by means of cable clips, to the fan shaft downstream of the second bulb, between this second bulb and the upstream end of the LP shaft, as access to this portion via the front of the engine is very difficult. One solution had been found, by installing a substantially radial part which was placed between the pipe for guiding the measurement wires and the first bulb of the disc, the latter being attached by fitting over the end of the bulb. However, this configuration had the second drawback of not being suited to modern engines which have no bulbs at the level of the fan shaft, the disc being of the disc-ring type which is continuous in the longitudinal direction.

The objective of the present invention is to solve these drawbacks by proposing a device for supporting a wire coming from a moving blade, allowing it to be secured regardless of the shape of the disc which bears said blade.

To that end, the invention relates to a turbomachine fitted with a device for gathering the information recorded during operation of the former by a strain gauge positioned on a fan blade borne by a fan disc of said turbomachine, said device comprising a hollow cylindrical pipe positioned inside one of the rotating shafts of said turbomachine in order to guide at least one wire for transmitting this information, characterized in that said device further comprises a part for attaching said pipe to said rotating shaft.

Fixing the attachment part to a rotating shaft of the turbomachine, preferably to a disc root as in the prior art, allows the device to be more compact and suitable for installation in modern engines. This device for gathering measurements is particularly suited to a fan blade loss test on a high-bypass ratio jet engine.

The attachment part preferably bears a part for guiding the wire towards its ingress into said pipe, said guiding part comprising a region, for gathering the excess lengths of said wire, formed by a wall extending in the axial direction and at least one wall extending in the radial direction. This region makes it possible to position therein the excess lengths of wire which are an intrinsic part of the design for measurement cabling and are necessary in order to allow them to be installed on the engine, without these excess lengths of wire hampering the operation of the turbomachine or being in danger of breaking under the effect of the forces generated by the rotation of the turbomachine.

In one preferred embodiment, the disc bearing the fan blades is a disc-ring. It even becomes essential to choose such a device when the fan disc does not comprise a bulb-shaped root.

In one particular embodiment, the rotating shaft is a low-pressure shaft, said shaft extending axially in the upstream direction until it is below said disc-ring.

Advantageously, said attachment part attaches to said rotating shaft by axially gripping splines which extend radially inside said shaft.

In one preferred embodiment, the guiding part extends axially in the upstream direction until it is in line with one of the axial ends of the fan disc. The wire for gathering the measurements then passes radially between the fan disc and the guiding part, which is beneficial for the integrity of the wire as the turbomachine rotates.

In one particular embodiment, the guiding part comprises an axial cylindrical portion from which a disc-shaped radial portion extends in the direction of said axial end of the fan disc. This disc-shaped portion can come as close as possible, and radially, to the fan disc which makes it easier for the wire to pass from the disc to the guiding part.

Preferentially, said radial portion extends towards the inside of said cylindrical portion via a radial extension which forms a wall of said region for gathering the excess lengths of wire.

In one particular embodiment, the radial portion of the guiding part comprises holes which allow the wire to pass from one of the faces of said disc to the opposite face.

The invention will be better understood, and other objectives, details, features and advantages thereof will become more clearly apparent from the following purely illustrative and non-limiting detailed explanatory description of an embodiment of the invention, with reference to the appended schematic drawings, in which:

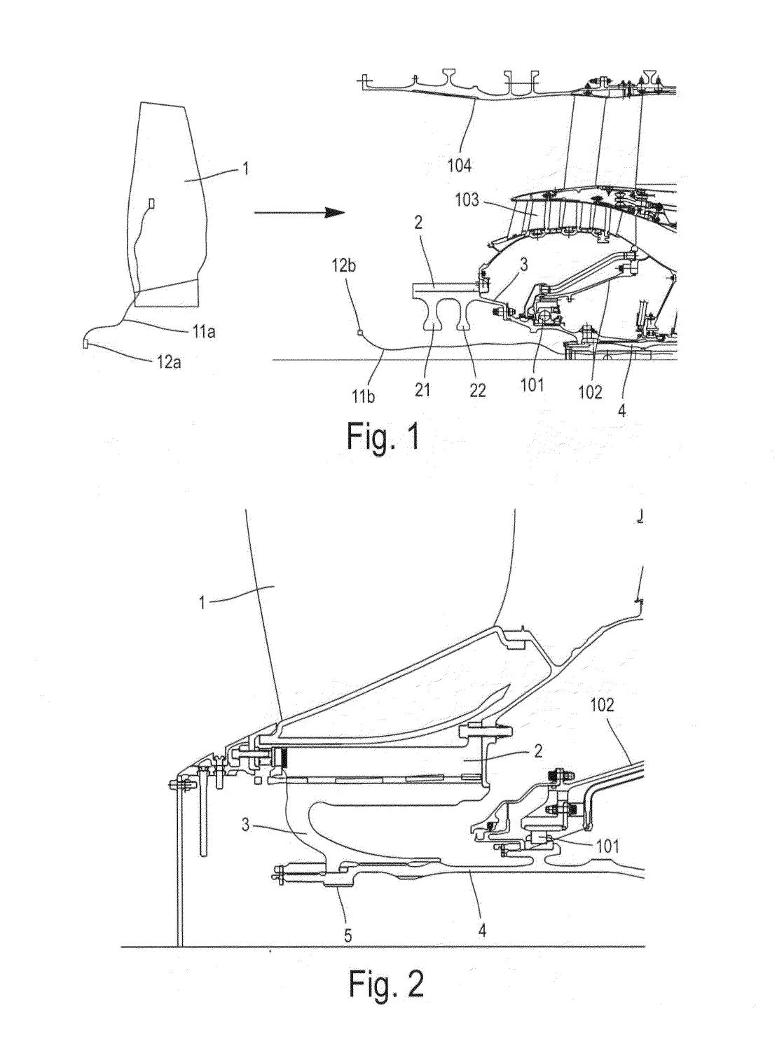

FIG. 1 is a view in section of the front portion of a turbomachine fitted with a measurement installation according to the prior art;

FIG. 2 is a view in section of the front portion of a turbomachine designed to receive a measuring device according to one embodiment of the invention;

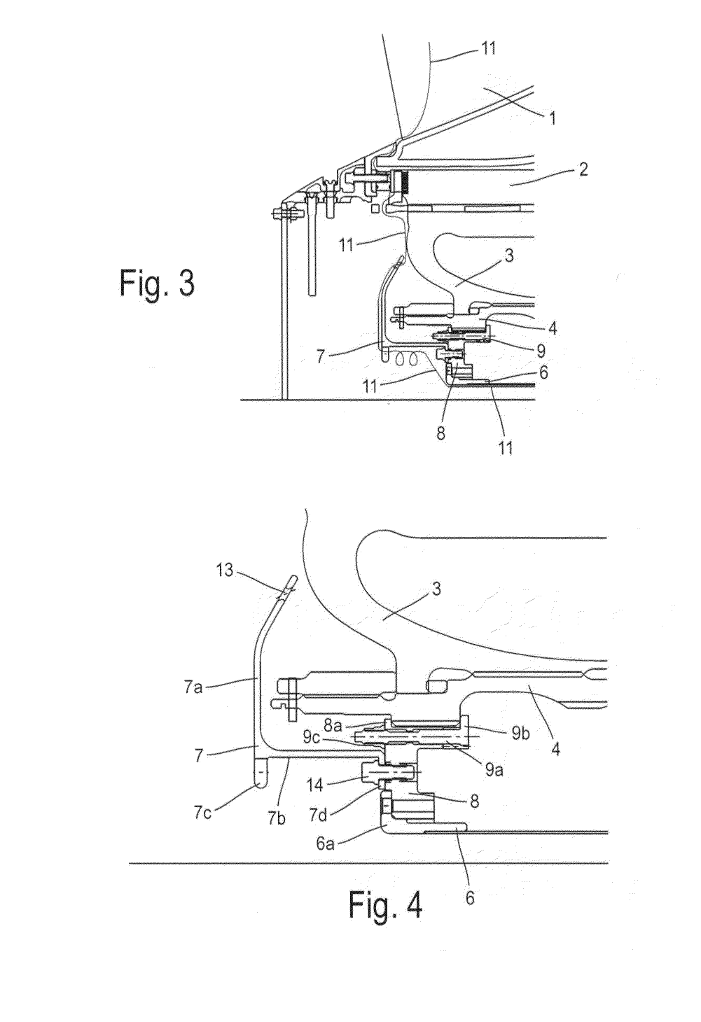

FIG. 3 is a view in section of the front portion of FIG. 2 fitted with a measuring device according to one embodiment of the invention;

FIG. 4 is a detail view of the device from FIG. 3, and

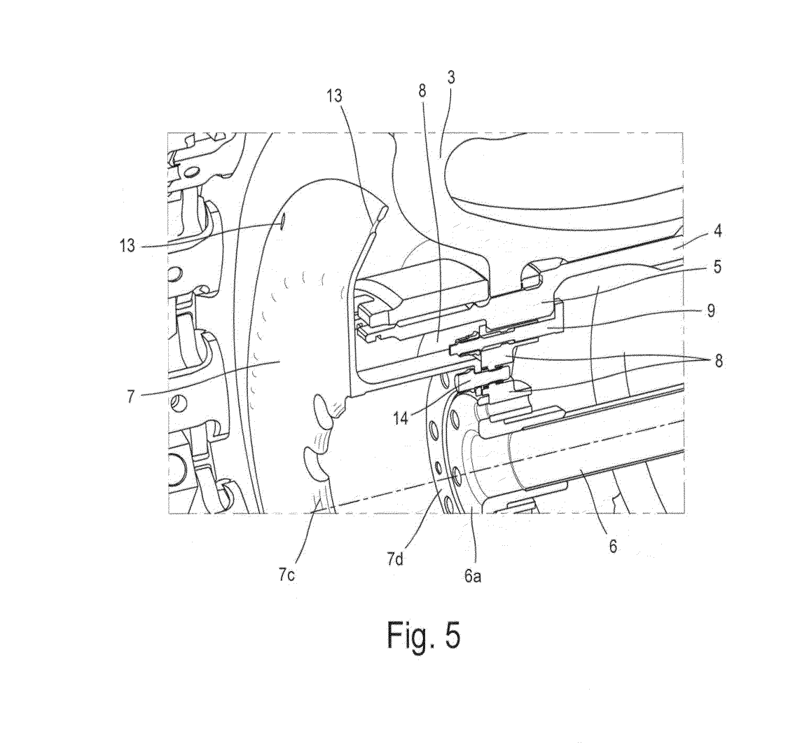

FIG. 5 is a view in section and in perspective of the device from FIG. 3.

FIG. 1 shows the front portion of a turbomachine of the prior art, comprising fan blades 1 which are not installed and are designed to be mounted on a fan disc 2 which in turn is attached, via its fan shaft 3, to the low-pressure compressor shaft or LP shaft 4. In a conventional configuration, the LP shaft is borne by a forward rolling bearing 101 which is itself borne by the structure of the intermediate casing 102 of the turbomachine. FIG. 1 also shows the low-pressure compressor 103 and the outer fan casing 104.

A strain gauge 10 is attached to the fan blade 1, a first section of wire 11a extending from the strain gauge in order to transmit the recorded strain information, wherein this wire ends at a first connector 12a. This first wire is connected, via a second connector 12b, to a second section of wire 11b so as to form the wire 11 for transmitting the data out of the turbomachine and to a system for recording the measurements during the projected test. The second section 11b extends towards the LP shaft 3, which it passes through to reach the device (not shown) for transferring the information from the rotating portion of the measurement installation to the stationary portion thereof

In the situation shown, which corresponds to a turbomachine of the prior art, the fan disc comprises two bulb-shaped radial extensions 21 and 22, between which there is a space serving as a wire storage space, inside which the excess lengths of measurement wire 11 could be coiled up after the fan blades 1 have been mounted on the fan shaft 3.

FIG. 2 shows the front portion of a modern engine, having no bulbs below the fan disc, these having been replaced by a ring-shaped cylindrical disc which extends beneath the root of the fan blades 1. The fan shaft 3 has a U-shaped (or more specifically a hairpin-shaped) cross section, so as to connect with the LP disc 4, which thus extends in the longitudinal direction to below the disc-ring 2. It should be noted that, as is conventional, the LP shaft comprises, on its internal face and at the level of its upstream end, notches 5 in the form of splines which prevent the LP shaft from rotating when the nut for attaching the fan disc 3 is tightened.

FIGS. 3 and 4 show the same front portion of the engine, having a pipe 6 for guiding the data transmission wire 11, installed for carrying out a blade failure test. The wire runs from the fan blade 1 to this pipe 6, first passing through the fan disc 2 in the region of the blade root slots, then along the upstream face of the fan shaft 3 and finally along a flange 7 for holding and guiding the wire towards the pipe 6. As can be seen in FIG. 4, this flange has, on the upstream side, a radial portion 7a in the shape of a recurved disc, which is positioned longitudinally substantially level with the upstream face of the fan shaft 3, so as to offer an extension for the wire in the radial continuity of this upstream face. It continues in the downstream direction via a cylindrical portion 7b which is coaxial with the engine and which ends at a radial attachment flange 7d so as to attach to a part 8 for supporting the pipe 6, which will be described in more detail below. The radial portion 7a, at that end which is close to the fan shaft 3, features a hole 13 which allows the wire 11 to pass through this flange from the concave side thereof, oriented towards the fan shaft 3, to the convex side and thus pass around the flange so as to reach the interior flank of its cylindrical portion 7b. Moreover, the radial portion 7a projects downwards via an extension 7c which extends below its axial portion 7a so as to form a barrier preventing the measurement wire 11 from returning in the upstream direction. The axial portion 7b thus forms, together with this radial extension 7c, a wire storage cavity, inside which the excess lengths of the wires 11 from the blades 1 being investigated can be positioned, as was the case in the prior art with the cavity between the bulbs.

At its upstream end, the pipe 6 for guiding the wire 11 has a crimped collar 6a which serves as an attachment flange for the pipe. This collar comprises, as is conventional, a series of holes arranged regularly around the periphery of the collar and designed to receive attachment means of the screw or nut-and-bolt type for fastening the pipe 6 on the support part 8 and, finally, through it, on the LP shaft 4, by means of which it is driven in rotation. In the remainder of the description the generic term “pipe” relates to the assembly formed of the pipe itself and its collar. The support part 8 is substantially in the shape of a hollow cylinder extending from the LP shaft 4, with which it is in contact by means of its notches 5, to the collar 6a of the pipe 6. It comprises at its upper portion an upstream lock 8a, in the form of a radial rib which extends in the axis of its upstream face and which comes to press against the radial upstream portion of the notch 5. Moreover, it features a first series of holes on its circumference, these holes accepting attachment means 9 of the nut-and-bolt type, wherein the bolt 9a bears, on the downstream side, a radial extension 9b which presses against the downstream radial portion of the notch 5. Tightening the nut 9c of the attachment means 9 against the upstream face of the support part 8 traps the notch 5 and locks the support part 8 in position on the LP shaft 4. By virtue of the anti-rotation function of the notches 5, this tightening secures the support part 8 and, therefore, the pipe 6 in rotation with the LP shaft 4 of the engine. The support part also has a second series of holes on its circumference, wherein these holes are tapped and receive the screws 14 for attaching the flange 7, which screws pass through the latter at the level of its radial attachment flange 7d. Finally, a third series of holes receives the screws for attaching the collar 6a of the pipe 6.

Finally, FIG. 5 shows in perspective, in the same way as FIG. 4, the arrangement of the various elements shown above. It should be noted, inter alia, that the flange 7 features, on its radial extension 7c, as many holes as necessary so as to be able to pass through it a tightening tool able to reach the screws or bolts for attaching the various elements fastened to the support part 8.

Mounting the measuring device thus involves installing the support part 8 at the level of the notches 5 of the LP shaft 4 and pressing its upstream rib 8a against the upstream face of said notch, then attaching this part using the attachment means 9. The bolt 9a is then pressed against the downstream face of the notch 5 and tightening the nut 9d causes the notch 5 to be trapped between the radial extension 9b of the bolt and the rib 8a of the support part. The support part being thus secured to the LP shaft 4, the pipe 6 is mounted thereon using screws or nut-and-bolt fasteners which pass through its collar 6a. Moreover, the flange 7 is also mounted on the support part 8, pressing its radial attachment flange 7d against the latter and attaching it using the nut-and-bolt fasteners 14.

It should be noted that these instrumentation means are mounted on the already-assembled turbomachine and that none of the components of the latter need be disassembled, provided that the strain gauges are already installed on the fan blades 1. All that remains to do is to connect the sections of wires from the gauges 11a to the sections of the measurement wires 11b at the connectors 12a and 12b and then to attach the wire 11 obtained, by means of cable clips, along its entire path over the various parts of the turbomachine, passing by the roots of the blades and passing through the flange 7 from the downstream side to the upstream side via the holes 13. The wire is placed such that it follows the shortest possible path and such that the excess lengths are gathered at the wire storage cavity formed by the radial extension 7c and the axial cylindrical portion 7b of the flange 7.

The various advantages provided by this configuration of the measurement installation device are, in addition to the fact that it is suitable for a turbomachine whose fan disc 2 is a disc-ring, that:
it is a relatively compact system which does not alter the behaviour of the fan disc when a blade is lost,
the engine is easier to mount on the test bench since the device can be installed once the turbomachine is assembled and already installed on the test bench, and
it is possible to install the system even in a small turbomachine and when there is very little available space.

1. Turbomachine fitted with a device for gathering the information recorded during operation of the former by a strain gauge positioned on a fan blade borne by a fan disc of said turbomachine, said device comprising a hollow cylindrical pipe positioned inside one of the rotating shafts of said turbomachine in order to guide at least one wire for transmitting this information,
characterized in that said device further comprises a part for attaching said pipe to said rotating shaft.

2. Turbomachine according to claim 1, wherein the attachment part bears a part for guiding the wire towards its ingress into said pipe, said guiding part comprising a region, for gathering the excess lengths of said wire, formed by a wall extending in the axial direction and at least one wall extending in the radial direction.

3. Turbomachine according to claim 1, wherein the disc bearing the fan blades is a disc-ring.

4. Turbomachine according to claim 3, wherein the rotating shaft is a low-pressure shaft (4), said shaft extending axially in the upstream direction until it is below said disc-ring.

5. Turbomachine according to claim 1, wherein said attachment part attaches to said rotating shaft by axially gripping splines which extend radially inside said shaft.

6. Turbomachine according to claim 2, wherein the guiding part extends axially in the upstream direction until it is in line with one of the axial ends of the fan disc.

7. Turbomachine according to claim 6, wherein the guiding part comprises an axial cylindrical portion from which a disc-shaped radial portion extends in the direction of said axial end of the fan disc.

8. Turbomachine according to claim 7, wherein said radial portion extends towards the inside of said cylindrical portion via a radial extension which forms a wall of said region for gathering the excess lengths of wire.

9. Turbomachine according to claim 7, wherein the radial portion of the guiding part comprises holes which allow the wire to pass from one of the faces of said disc to the opposite face.
